(19) United States
(12) Patent Application Publication
(10) Pub. No.: US 2007/0244258 A1
(43) Pub. Date: Oct. 18, 2007

(54) Clear coating compositions with improved scratch resistance

(76) Inventors: Shanti Swarup, Allison Park, PA (US); Richard J. Sadvary, Pittsburgh, PA (US); Dennis A. Simpson, Sarver, PA (US); Davina J. Schwartzmiller, Allison Park, PA (US); Kurt G. Olson, Gibsonia, PA (US)

Correspondence Address: PPG INDUSTRIES INC;INTELLECTUAL PROPERTY DEPT, ONE PPG PLACE, PITTSBURGH, PA, 15272, US

(21) Appl. No.: 11/392,126

(22) Filed: Mar. 29, 2006

(51) Int. Cl. C08L 67/02

(52) U.S. Cl. 525/165; 525/124; 525/171; 525/176

(57) ABSTRACT

A clear coating composition for use over a colored basecoat having improved scratch resistance is disclosed. The coating composition comprises a film-forming polymer and a curing agent. The improvement is due to the incorporation in the clear coating composition of an adjuvant resin having functional groups reactive with the curing agent and positioned between the functional groups a moiety having a hydrocarbon chain of at least 10 contiguous carbon atoms.

### FIELD OF THE INVENTION

The present invention relates to coating compositions; particularly coating compositions that are used to form clear coats, and more particularly clear coats in color, clear composite coatings.

### BACKGROUND OF THE INVENTION

Color-plus-clearcoating systems involving the application of a colored or pigmented basecoat to a substrate followed by application of a transparent or clear coat over at least a portion of the basecoat have become increasingly popular as original finishes for a number of consumer products including, for example automotive vehicles. The color-plus-clearcoating systems have outstanding appearance properties such as gloss and distinctness of image, due in large part to the clear coat. Such color-plus-clearcoating systems have become popular for use with automotive vehicles, aerospace applications, floor coverings such as ceramic tiles and wood flooring, packaging coatings and the like.

The clear coat in such composite coatings can be prone to scratching. This is particularly noticeable when the clear coat is used in automotive applications and is subject to commercial car washes. Thin scratch lines can develop after repeated washings where the cleaning brushes impact the clear coat. These scratch lines can decrease the gloss of the coating and are visually unappealing.

Therefore it would be desirable to provide a coating composition useful as a clear coat with improved scratch resistance.

### SUMMARY OF THE INVENTION

The present invention provides a clear coating composition for use over a colored basecoat comprising
(a) a polymeric film-forming material having reactive functional groups, and
(b) a curing agent having functional groups reactive with the functional groups of (a), and
(c) optionally inorganic particles.

Further included in the coating composition is an adjuvant resin having two or more terminal functional groups reactive with the functional groups of (b) and positioned between the functional groups a moiety having a hydrocarbon chain of at least 10 contiguous carbon atoms. The polymer has a functional group equivalent weight of 100-500 and the improved coating composition is characterized as having a Fischer Hardness Value of between 90 and 160.

The invention also provides for a multilayer composite coating on a substrate comprising a colored basecoat and a clear topcoat in which the clear topcoat is deposited on the colored basecoat from the clear coating composition mentioned above.

### DETAILED DESCRIPTION

Other than in the operating examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The adjuvant resin that is used in the present invention can be an oligomer or polymer. The adjuvant resin has two or more, usually more than 2, terminal functional groups reactive with the functional groups of the curing agent. Positioned between the terminal functional groups is a moiety having a hydrocarbon chain of at least 10, such as at least 16, for example as from 16 to 40 contiguous carbon atoms. The adjuvant resin is highly functional having a functional group equivalent weight of 90 to 500, such as 200 to 400 and a number average molecular weight ranging from 200 to 10,000, such as 500 to 5,000 grams per mole as determined by gel permeation chromatography using a polystyrene standard.

The adjuvant resin can provide elasticity in the resultant coating while not detracting from the hardness of the coating. It is believed that the elasticity provided by the adjuvant resin is principally responsible for the scratch resistance of the coating; while a degree of hardness is necessary to maintain resistance to water spotting and acid etching. The desired blend of flexibility and hardness can be determined by the Fischer Hardness Value. Accordingly, the cured coating containing the adjuvant resin should have a Fischer Hardness Value of 90 to 160, such as 100 to 140. The Fischer Hardness Value is the Fischer Micro Hardness Value as measured by a Fischerscope HCU (H100V-HCU program and control version HCU 19) available from Helmut Fischer GmbH.

The adjuvant resin can be linear or branched, with terminal functional groups that are reactive with the functional groups of the curing agent. Examples of such functional groups include, but are not limited to active hydrogen groups, such as hydroxyl groups, primary and secondary amine groups, carbamate groups, mercaptan groups, amide groups and/or urea groups.

The adjuvant resin can be a polyester prepared from reacting a polyol with a polycarboxylic acid with the hydrocarbon chain derived from the polycarboxylic acid. Examples of suitable polycarboxylic acids include, but are not limited to linear or branched polycarboxylic acid having from 2 to 4 carboxylic acid groups and containing a hydrocarbon chain of at least 10, such as at least 16, for example from 16 to 40 contiguous carbon atoms between the carboxylic acid groups. Examples of suitable polycarboxylic acids are 1-10-decane dicarboxylic acid; 1-12-dodene dicarboxylic acid, dimer and polymeric fatty polycarboxylic acid such as those sold under the trademark EMPOL such as EMPOL 1008, EMPOL 1010 available from Cognis, and PRIPOL 1013 available from Uniquema.

The esterification reaction is carried out in accordance with techniques that are well known to those skilled in the art of polymer chemistry and a detailed discussion is not believed to be necessary. Generally, the reaction can be conducted by combining the ingredients and heating to a temperature of 160° C. to 230° C. Further details of the esterification process are disclosed in U.S. Pat. No. 5,468,802 at column 3, lines 4-20 and 39-45.

Generally, the adjuvant resin can be present in an amount ranging from 1 to 50 weight percent on a basis of total resin solids of the topcoat coating composition, such as from 2 to 40 weight percent, for example 5 to 30 weight percent.

The base coating composition into which the adjuvant is included comprises (a) a polymeric film-forming material having reactive functional groups and (b) a curing agent having functional groups reactive with the functional groups of (a) and optionally inorganic particles.

The reactive functional groups can be selected from hydroxyl, primary and secondary amine, thiol, carboxylic acid, and isocyanate including blocked isocyanate, amide, carbamate and/or epoxy groups. Examples of suitable polymers containing these reactive functional groups can include acrylic polymers, polyesters and polyurethanes among others.

Suitable hydroxyl group and/or carboxyl group-containing acrylic polymers can be prepared from polymerizable ethylenically unsaturated monomers and can be copolymers of (meth)acrylic acid and/or hydroxylalkyl esters of (meth)acrylic acid with one or more other polymerizable ethylenically unsaturated monomers such as, for example alkyl esters of (meth)acrylic acid including methyl(meth)acrylate, ethyl(meth)acrylate, butyl(meth)acrylate and 2-ethyl hexylacrylate, and vinyl aromatic compounds such as, for example styrene, alpha-methyl styrene, and vinyl toluene. As used herein, “(meth)acrylate” and like terms are intended to include both acrylates and methacrylates.

Epoxy functional groups can be incorporated into the polymer prepared from polymerizable ethylenically unsaturated monomers by copolymerizing oxidant group-containing monomers, for example glycidyl(meth)acrylate and allyl glycidyl ether, with other polymerizable ethylenically unsaturated monomers such as those discussed above. Preparation of such epoxy functional acrylic polymers is described in detail in U.S. Pat. No. 4,001,156 at columns 3 to 6.

Carbamate functional groups can be incorporated into the polymer prepared from polymerizable ethylenically unsaturated monomers by copolymerizing, for example the above-described ethylenically unsaturated monomers with a carbamate functional vinyl monomer such as a carbamate functional alkyl ester of methacrylic acid. Useful carbamate functional alkyl esters can be prepared by reacting, for example a hydroxyalkyl carbamate (which can be the reaction product of ammonia and ethylene carbonate or propylene carbonate) with methacrylic anhydride.

The polymers prepared from polymerizable ethylenically unsaturated monomers can be prepared by solution polymerization techniques, which are well-known to those skilled in the art, in the presence of suitable catalysts such as organic peroxides or azo compounds, for example benzoyl peroxide or N,N-azobis(isobutylronitrile). The polymerization can be carried out in an organic solution in which the monomers are soluble by techniques conventional in the art. Alternatively, these polymers can be prepared by aqueous emulsion or dispersion polymerization techniques that are well known in the art. The ratio of reactants and reaction conditions are selected to result in an acrylic polymer with the desired pendent functionality.

Polyester polymers also are useful in the coating compositions of the invention as the additional polymer. Useful polyester polymers can comprise the condensation products of polyhydric alcohols and polycarboxylic acids. Nonlimiting examples of suitable polyhydric alcohols include ethylene glycol, neopentyl glycol, trimethylol propane, and pentaerythritol. Nonlimiting examples of suitable polycarboxylic acids include adipic acid, 1,4-cyclohexyl dicarboxylic acid, and hexahydrophthalic acid. Besides the polycarboxylic acids mentioned above, functional equivalents of the acids such as anhydrides where they exist or lower alkyl esters of the acids such as the methyl esters can be used. Also, small amounts of monocarboxylic acids such as stearic acid can be used. The ratio of reactants and reaction conditions are selected to result in a polyester polymer with the desired pendent functionality, i.e., carboxyl or hydroxyl functionality.

For example, hydroxyl group-containing polyesters can be prepared by reacting an anhydride of a dicarboxylic acid such as hexahydrophthalic anhydride with a diol such as neopentyl glycol in a 1:2 molar ratio.

Carbamate functional polyesters can be prepared by first forming a hydroxyalkyl carbamate that can be reacted with the polyacids and polyols used in forming the polyester. Alternatively, terminal carbamate functional groups can be incorporated into the polyester by reacting isocyanic acid with a hydroxy functional polyester.

Polyurethane polymers containing terminal isocyanate or hydroxyl groups also can be used as the additional polymer in the coating compositions of the invention. The polyurethane polyols or NCO-terminated polyurethanes that can be used are those prepared by reacting polyols including polymeric polyols with polyisocyanates. Polyureas containing terminal isocyanate or primary and/or secondary amine groups which also can be used can be those prepared by reacting polyamines including, but not limited to, polymeric polyamines with polyisocyanates.

The hydroxyl/isocyanate or amine/isocyanate equivalent ratio can be adjusted and reaction conditions can be selected to obtain the desired terminal groups. Nonlimiting examples of suitable polyisocyanates include those described in U.S. Pat. No. 4,046,729 at column 5, line 26 to column 6, line 28 the cited portions of which are incorporated herein by reference. Nonlimiting examples of suitable polyols include those described in U.S. Pat. No. 4,046,729 at column 7, line 52 to column 10, line 35 the cited portions of which are incorporated herein by reference. Nonlimiting examples of suitable polyamines include those described in U.S. Pat. No. 4,046,729 at column 6, line 61 to column 7, line 32 and in U.S. Pat. No. 3,799,854 at column 3, lines 13 to 50 the cited portions of which are incorporated herein by reference.

Carbamate functional groups can be introduced into the polyurethane polymers by reacting a polyisocyanate with a polyester having hydroxyl functionality and containing pendent carbamate groups. Alternatively, the polyurethane can be prepared by reacting a polyisocyanate with a polyester polyol and a hydroxyalkyl carbamate or isocyanic acid as separate reactants. Nonlimiting examples of suitable polyisocyanates include aromatic isocyanates, (such as 4,4′-diphenylmethane diisocyanate, 1,3-phenylene diisocyanate, and toluene diisocyanate), and aliphatic polyisocyanates (such as 1,4-tetramethylene diisocyanate, and 1,6-hexamethylene diisocyanate). Cycloaliphatic diisocyanates, such as, for example 1,4-cyclohexyl diisocyanate and isophorone diisocyanate can be employed.

Examples of curing agents can include aminoplast and phenoplast resins, polyisocyanates including blocked polyisocyanates, anhydrides, polyepoxides, polyacids, polyols and/or polyamines.

Aminoplast resins and phenoplast resins and mixtures thereof, as curing agents for OH and COOH, amide and carbamate functional group containing materials are well known in the art. Examples of aminoplast and phenoplast resins suitable as curing agents in the curable compositions of the present invention are those described in U.S. Pat. No. 3,919,351 at col. 5, line 22 to col. 6, line 25 the cited portions of which are incorporated herein by reference.

Polyisocyanates and blocked polyisocyanates as curing agents for OH and primary and/or secondary amino group containing materials are well known in the art. Examples of polyisocyanates and blocked isocyanates suitable for use as curing agents in the curable compositions of the present invention include those described in U.S. Pat. No. 4,546,045 at col. 5, lines 16 to 38; and in U.S. Pat. No. 5,468,802 at col. 3, lines 48 to 60 the cited portions of which are incorporated herein by reference.

Anhydrides as curing agents for OH and primary and/or secondary amino group containing materials are well known in the art. Examples of anhydrides suitable for use as curing agents in the curable compositions of the present invention include those described in U.S. Pat. No. 4,798,746 at Col. 10, lines 16 to 50; and in U.S. Pat. No. 4,732,790 at col. 3, lines 41 to 57 the cited portions of which are incorporated herein by reference.

Polyepoxides as curing agents for COOH functional group containing materials are well known in the art. Examples of polyepoxides suitable for use as curing agents in the curable compositions of the present invention are those described in U.S. Pat. No. 4,681,811 at col. 5, lines 33 to 58 the cited portions of which are incorporated herein by reference.

Polyacids as curing agents for epoxy functional group containing materials are well known in the art. Examples of polyacids suitable for use as curing agents in the curable compositions of the present invention are those described in U.S. Pat. No. 4,681,811 at col. 6, line 45 to col. 9, line 54 the cited portions of which are incorporated herein by reference.

Polyols, that is, material having an average of two or more hydroxyl groups per molecule, can be used as curing agents for NCO functional group containing materials and anhydrides and esters and are well known in the art. Examples of said polyols are those described in U.S. Pat. No. 4,046,729 at col. 7, line 52 to col. 8, line 9; col. 8, line 29 to col. 9, line 66; and in U.S. Pat. No. 3,919,315 at col. 2, line 64 to col. 3, line 33 the cited portions of which are incorporated herein by reference.

Polyamines can also be used as curing agents for NCO functional group containing materials and for carbonates and unhindered esters and are well known in the art. Examples of polyamines suitable for use as curing agents in the curable compositions of the present invention are those described in U.S. Pat. No. 4,046,729 at col. 6, line 61 to col. 7, line 26 the cited portions of which are incorporated herein by reference.

The film-forming polymer is typically present in the coating composition in amounts ranging from 20 to 75, such as 40 to 65 percent by weight based on resin solids of the composition. The curing agent is typically present in amounts ranging from 20 to 75, such as 25 to 55 percent by weight, based on resin solids of the composition.

The clear coating compositions can be in the form of a one or two component system depending on the reactivity of the polymeric film-forming material and the curing agent. Two-component systems comprising hydroxyl containing polymeric film-forming materials and polyisocyanate curing agents are preferred as are one-component systems comprising hydroxyl containing polymeric film-forming materials and aminoplast resins.

The inorganic particles that are optionally contained in the coating composition can be ceramic materials, metallic materials including metalloid materials. Suitable ceramic materials comprise metal oxides, metal nitrides, metal carbides, metal sulfides, metal silicates, metal borides, metal carbonates, and mixtures of any of the foregoing. Specific, nonlimiting examples of metal nitrides are, for example boron nitride; specific, nonlimiting examples of metal oxides are, for example zinc oxide; nonlimiting examples of suitable metal sulfides are, for example molybdenum disulfide, tantalum disulfide, tungsten disulfide, and zinc sulfide; nonlimiting suitable examples of metal silicates are, for example aluminum silicates and magnesium silicates such as vermiculite.

In one embodiment of the present invention, the inorganic particle comprises silica including fumed silica, amorphous silica, colloidal silica, alumina, colloidal alumina, titanium dioxide, cesium oxide, yttrium oxide, colloidal yttria, zirconia, colloidal zirconia, and mixtures of any of the foregoing. In another embodiment, the present invention is directed to cured compositions as previously described wherein the particles include colloidal silica. As disclosed above, these materials can be surface treated or untreated.

The coating composition can comprise precursors suitable for forming silica particles in situ by a sol-gel process. The coating composition according to the present invention can comprise alkoxy silanes that can be hydrolyzed to form silica particles in situ. For example tetraethylortho silicate can be hydrolyzed with an acid such as hydrochloric acid and condensed to form silica particles. Other useful particles include surface-modified silicas such as are described in U.S. Pat. No. 5,853,809 at column 6, line 51 to column 8, line 43 the cited portions of which are incorporated herein by reference.

It should be understood that since the cured composition of the invention is employed as a clear coat in a multi-component composite coating composition, particles should not seriously interfere with the optical properties of the cured composition. As used herein, “transparent” means that the cured coating has a BYK Haze index of less than 50 as measured using a BYK/Haze Gloss instrument.

The inorganic particles when present in the composition are present in amounts of up to 10, such as 1 to 10, for example 1 to 5 percent by weight based on total weight of the coating composition.

In addition to the foregoing components, the coating compositions of the invention may include one or more optional ingredients such as plasticizers, anti-oxidants, light stabilizers, mildewcides and fungicides, surfactants and flow control agents or catalysts as are well known in the art. These components when present are present in amounts less than 40 percent by weight based on total weight of the coating composition.

The components present in the curable coating composition of the present invention generally are dissolved or dispersed in an organic solvent. Organic solvents that may be used include, for example, alcohols, ketones, aromatic hydrocarbons, glycol ethers, esters or mixtures thereof. The organic solvent is typically present in amounts ranging from 5 to 80 percent by weight based on total weight of the composition.

The coating compositions of the present invention when deposited on a substrate have good gloss and scratch resistance as measured by gloss retention after abrasive testing.

The initial 200 gloss of a cured coated substrate according to the present invention is usually at least 70, such as at least 80 as measured with a 20° NOVO-GLOSS 20 statistical gloss meter, available from Gardner Instrument Company, Inc.

The coated substrate can be subjected to scratch testing as described in the Examples. After testing, the test panels are then rinsed with tap water and carefully patted dry with a paper towel. The 20° gloss is measured on the scratched area of each test panel.

Typically, after scratch testing (40 cycles), at least 30, such as at least 40, for example at least 50 percent of the initial 20° gloss is retained.

In order to achieve the desired gloss retention after scratch testing, the cured coatings have a Fischer Hardness Value of 90 to 160. Values higher than 160 are undesirable because the film is too brittle and easily scratches. Values less than 90 are undesirable because the film is too soft and prone to water spotting and acid etching.

Illustrating the invention are the following examples that are not to be considered as limiting the invention to their details. All parts and percentages in the examples as well as throughout the specification are by weight unless otherwise indicated.

### EXAMPLES

### Examples A-D

The following examples show the preparation of various hydroxyl functional polyesters. The polyesters of Examples A and B are in accordance with the present invention. These polyesters have three terminal hydroxyl groups and positioned between the terminal hydroxyl groups is a moiety having a hydrocarbon chain of at least 10 carbon atoms. The polyesters have an equivalent weight between 100 and 500.

The polyesters of Examples C and D were prepared for comparative purposes. These polyesters are similar to A and B but do not contain the moiety having a hydrocarbon chain of at least 10 carbon atoms between the terminal hydroxyl groups.

### Adjuvant Resin Examples

Example A

This example describes the preparation of a polyester polymer used as a component in coating compositions of Examples 1-4 of the present invention. The polyester was prepared from the following ingredients.

| INGREDIENTS | PARTS BY WEIGHT (grams) |
|---|---|
| PRIPOL 1013¹ | 508.5 |
| Adipic acid | 392.8 |
| Trimethylol propane | 947.1 |
| Butyl stannoic acid | 1.8 |
| Methyl ether propylene glycol acetate | 2241.7 |

¹dimer diacid available from Uniqema.

The polyester polymer was prepared in a four-neck round bottom flask equipped with a thermometer, mechanical stirrer, condenser, dry nitrogen sparge and a heating mantle. The first four ingredients were heated to a temperature of 200° C. and stirred in the flask until about 120 grams of distillate was collected and the acid value dropped below 1.5. The material was then cooled to a temperature of 130° C. and methyl ether propylene glycol acetate was added. The final product was a liquid having a non-volatile content of 85% (as measured at 110° C. for one hour), and hydroxyl value of 373, a weight averaged molecular weight of 3043 as measured by gel permeation chromatography and a hydroxyl equivalent weight of 125.

### Example B

This example describes the preparation of a polyester polymer used as a component in the coating composition of Example 5 of the present invention. The polyester was prepared from the following ingredients as described below.

| INGREDIENTS | PARTS BY WEIGHT (grams) |
|---|---|
| PRIPOL 1013 | 493.5 |
| 1,4-cyclohexanedicarboxylic acid | 449.1 |
| Trimethylol propane | 919.1 |
| Butyl stannoic acid | 2.6 |
| Methyl ether propylene glycol acetate | 261.1 |

The polyester polymer was prepared in a four-neck round bottom flask equipped with a thermometer, mechanical stirrer, condenser, dry nitrogen sparge and a heating mantle. The first four ingredients were heated to a temperature of 200° C. and stirred in the flask until about 125.3 grams of distillate was collected and the acid value dropped below 1.5. The material was then cooled to a temperature of 130° C. and methyl ether propylene glycol acetate was added. The final product was a liquid having a non-volatile content of 85% (as measured at 110° C. for one hour), and hydroxyl value of 361.7, a weight averaged molecular weight of 3029 as measured by gel permeation chromatography and a hydroxyl equivalent weight of 125.

### Example C (Comparative)

This example describes the preparation of a polyester polymer used as a component in the comparative coating compositions of Example 6-9. The polyester was prepared from the following ingredients as described below.

| INGREDIENTS | PARTS BY WEIGHT (grams) |
|---|---|
| Adipic acid | 292.0 |
| Trimethylol propane | 528.0 |
| Butyl stannoic acid | 0.8 |
| Triphenyl phosphate | 0.8 |
| Butyl acetate | 205.4 |

The polyester polymer was prepared in a four-neck round bottom flask equipped with a thermometer, mechanical stirrer, condenser, dry nitrogen sparge and a heating mantle. The first four ingredients were heated to a temperature of 200° C. and stirred in the flask until about 30 grams of distillate was collected and the acid value dropped below 1.5. The material was then cooled to a temperature of 130° C. and butyl acetate was added. The final product was a liquid having a non-volatile content of 80% (as measured at 110° C. for one hour), and hydroxyl value of 457, weight averaged molecular weight of 2511 as measured by gel permeation chromatography, and a hydroxyl equivalent weight of 98.

### Example D (Comparative)

This example describes the preparation of a polyester polymer used as a component in the comparative coating compositions of Examples 10-13. The polyester was prepared from the following ingredients as described below.

| INGREDIENTS | PARTS BY WEIGHT (grams) |
|---|---|
| Isophthalic acid | 498.0 |
| Trimethylol propane | 792.0 |
| Butyl stannoic acid | 1.2 |
| Triphenyl phosphate | 1.2 |
| Butyl acetate | 323.1 |

The polyester polymer was prepared in a four-neck round bottom flask equipped with a thermometer, mechanical stirrer, condenser, dry nitrogen sparge and a heating mantle. The first four ingredients were heated to a temperature of 200° C. and stirred in the flask until about 78 grams of distillate was collected and the acid value dropped below 1.5. The material was then cooled to a temperature of 130° C. and butyl acetate was added. The final product was liquid and had a non-volatile content of 80% (as measured at 110° C. for one hour), and hydroxyl value of 443, weight averaged molecular weight of 2234 as measured by gel permeation chromatography and a hydroxyl equivalent weight of 101.

### Formulated Coating Examples

The following Examples 1 to 5 show coating compositions of the present invention in which the adjuvant resins of the invention (Examples A and B) are incorporated into the coating compositions in various amounts. These compositions were compared to similar coating compositions (Comparative Examples 6 to 13) but using the adjuvant resins of Examples C and D instead of Examples A and B. For the purposes of a control, a coating composition with no adjuvant resin (Example 14) was also evaluated.

Comparison was done on the cured coatings. Gloss (20° gloss), Distinctiveness of Image (DOI), Hardness and Scratch Resistance were determined and compared. The various coating compositions were used to form clear coats over colored basecoats. The formulations for Examples 1-5 are shown in Table I and the formulations for Examples 6-14 are shown in Table II. The amounts shown in the tables represent parts by weight. Solids parts by weight are shown within the parentheses.

Each component shown in Tables I and II was mixed sequentially with agitation to form the A Package and the B Package. The A Package and the B Package were then mixed together with agitation to form the clear coating compositions. The amounts shown in the Tables are parts by weight in grams. The amounts within parenthesis are parts by weight on a solids basis.

The treated silica used in Examples 1-14 was prepared from the following charge. Amounts are parts by weight in grams.

CHARGE

| | | |
|---|---|---|
| Charge 1 | Snowtex O¹ | 53627.3 |
| | Grams of Water Removed | 5.7 |
| Charge 2 | Isopropanol | 48500.5 |
| Charge 3 | Acryloxypropyltrimethoxysilane | 2676.8 |
| | Methacryloxypropyltrimethoxysilane | — |
| Charge 4 | Butoxyethanol | 107254.68 |
| | % residual | <0.01 |
| | Wgt. Removed by atmospheric distillation | 48092.20 |
| | Wgt. Removed by vacuum distillation | 63518.00 |
| Charge 5 | Octyltriethoxysilane [OTES] | 536.3 |
| Charge 6 | Dibutyltindilaurate (DBTDL) | 107.3 |
| | Final % Solids | 16.4 |
| | Final % Water | 0.0564 |

¹Silica particles available from Nissan Chemical Industries Ltd.

A 3-liter flask equipped with a stirrer, thermometer, and addition funnel is set for reflux and Charge 1 is added. The contents of the flask are then heated to reflux (95-98° C.) and the weight of water as noted is removed. The reactor is set for total reflux and the more concentrated dispersion is then cooled to 30-40° C. Charges 2, 3 and 4 are then added. The mixture is stirred for one hour with no additional heating. Optionally, the reaction mixture is checked to determine the % of the acryloxypropyltrimethoxysilane remaining unreacted. The flask is then configured for distillation and the indicated amount of volatiles as noted is removed under atmospheric distillation. Vacuum is then applied to remove additional material as noted. The contents of the flask are then cooled to room temperature with stirring. Charges 5 and 6 are added and the mixture is heated to 80° C. for 6 hours. The final material is a fluid, translucent liquid at about 15-17% solids.

TABLE I
Coating Formulations of the Invention

| Ingredient | EX 1 | | EX 2 | | EX 3 | | EX 4 | | EX 5 | |
|---|---|---|---|---|---|---|---|---|---|---|
| A Package | | | | | | | | | | |
| Amyl Acetate | 38.81 | | 37.15 | | 35.00 | | 35.00 | | 38.00 | |
| Butyl CARBITOL ® | 3.0 | | 3.0 | | 3.0 | | 3.0 | | 3.0 | |
| Acetate¹ | | | | | | | | | | |
| Tinuvin ® 123² | 0.5 | (0.5) | 0.5 | (0.5) | 0.5 | (0.5) | 0.5 | (0.5) | 0.5 | (0.5) |
| Tinuvin ® 928³ | 3.0 | (3.0) | 3.0 | (3.0) | 3.0 | (3.0) | 3.0 | (3.0) | 3.0 | (3.0) |
| Treated Silica | 13.89 | (2.0) | 13.89 | (2.0) | 13.89 | (2.0) | 13.89 | (2.0) | 13.89 | (2.0) |
| Acrylic Polyol⁴ | 90.28 | (57.33) | 72.43 | (45.99) | 52.03 | (33.04) | 34.19 | (21.71) | 72.93 | (46.31) |
| CYMEL ® 202⁵ | 6.25 | (5.00) | 6.25 | (5.00) | 6.25 | (5.00) | 6.25 | (5.00) | 6.25 | (5.00) |
| BYK ® 306⁶ | 0.15 | (0.02) | 0.15 | (0.02) | 0.15 | (0.02) | 0.15 | (0.02) | 0.15 | (0.02) |
| Polyester of Ex. A | 3.53 | (3.0)⁹ | 11.76 | (10.00)¹⁰ | 21.18 | (18.00)¹¹ | 29.41 | (25.00)¹² | — | |
| Polyester of Ex. B | — | | — | | — | | — | | 12.30 | (10.00)¹³ |
| B Package | | | | | | | | | | |
| Phenyl Acid | 0.67 | (0.50) | 0.67 | (0.50) | 0.67 | (0.50) | 0.67 | (0.50) | 0.67 | (0.50) |
| Phosphate Catalyst⁷ | | | | | | | | | | |
| DESMODUR N | 34.67 | | 39.00 | | 43.95 | | 48.29 | | 38.68 | |
| 3300A⁸ | | | | | | | | | | |

¹Diethylene glycol monobutyl ether acetate available from Dow Chemical.
²U.V. light stabilizer available from Ciba Geigy.
³U.V. light stabilizer available from Ciba Geigy.
⁴14% butyl methacrylate, 15% butyl acrylate, 28% isobornyl methacrylate, 23% hydroxypropyl methacrylate, 20% hydroxyethyl methacrylate as 63.5% solids in a solvent blend of [95% propylene glycol methyl ether (DOWANOL PM from Dow Chemical) and 5% SOLVESSO 100 (aromatic hydrocarbon from Exxon)].
⁵Melamine-formaldehyde resin available from Cytec.
⁶Flow additive available from BYK-Chemie USA in 2-methoxy acetone.
⁷In isopropanol.
⁸Isocyanurate of hexamethylene diisocyanate available from Bayer (100% solids).
⁹3% by weight based on resin solids weight.
¹⁰10% by weight based on resin solids weight.
¹¹18% by weight based on resin solids weight.
¹²25% by weight based on resin solids weight.
¹³10% by weight based on resin solids weight.

TABLE II
Comparative Coating Formulation

| Ingredient | Ex 6 | | Ex 7 | | Ex 8 | | Ex 9 | | Ex 10 | |
|---|---|---|---|---|---|---|---|---|---|---|
| A Package | | | | | | | | | | |
| Amyl Acetate | 38.00 | | 37.01 | | 35.00 | | 35.00 | | 40.00 | |
| Butyl | 3.0 | | 3.0 | | 3.0 | | 3.0 | | 3.0 | |
| CARBITOL ® | | | | | | | | | | |
| Acetate | | | | | | | | | | |
| Tinuvin 123 | 0.5 | (0.5) | 0.5 | (0.5) | 0.5 | (0.5) | 0.5 | (0.5) | 0.5 | (0.5) |
| Tinuvin 928 | 3.0 | (3.0) | 3.0 | (3.0) | 3.0 | (3.0) | 3.0 | (3.0) | 3.0 | (3.0) |
| Treated Silica | 13.89 | (2.00) | 13.89 | (2.00) | 13.89 | (2.00) | 13.89 | (2.00) | 13.89 | (2.00) |
| Acrylic Polyol | 89.17 | (56.62) | 68.74 | (43.65) | 45.40 | (28.83) | 24.98 | (15.86) | 89.34 | (50.73) |
| CYMEL 202 | 6.25 | (5.0) | 6.25 | (5.0) | 6.25 | (5.0) | 6.25 | (5.0) | 6.25 | (5.0) |
| BYK 306 | 0.15 | (0.02) | 0.15 | (0.02) | 0.15 | (0.02) | 0.15 | (0.02) | 0.15 | (0.02) |
| Polyester of | 3.75 | (3.00) | 12.48 | (10.00) | 22.47 | (18.00) | 31.21 | (25.00) | — | |
| Comparative | | | | | | | | | | |
| Ex C | | | | | | | | | | |
| Polyester of | — | | — | | — | | — | | 3.28 | (3.00) |
| Comparative | | | | | | | | | | |
| Ex D | | | | | | | | | | |
| B Package | | | | | | | | | | |
| Phenyl Acid | 0.67 | (0.50) | 0.67 | (0.50) | 0.67 | (0.50) | 0.67 | (0.50) | 0.67 | (0.50) |
| Phosphate | | | | | | | | | | |
| Catalyst | | | | | | | | | | |
| DESMODUR N | 35.37 | | 41.34 | | 48.17 | | 54.14 | | 35.26 | |
| 3300A | | | | | | | | | | |

| | | | | |
|---|---|---|---|---|
| Ingredient | Ex 11 | Ex 12 | Ex 13 | Ex 14 |

| | | | | | | | | |
|---|---|---|---|---|---|---|---|---|
| A Package | | | | | | | | |
| Amyl Acetate | 39.00 | | 39.70 | | 38.50 | | 39.28 | |
| Butyl | 3.0 | | 3.0 | | 3.0 | | 3.0 | |
| CARBITOL ® | | | | | | | | |
| Acetate | | | | | | | | |
| Tinuvin 123 | 0.5 | (0.5) | 0.5 | (0.5) | 0.5 | (0.5) | 0.5 | (0.5) |
| Tinuvin 928 | 3.0 | (3.0) | 3.0 | (3.0) | 3.0 | (3.0) | 3.0 | (3.0) |
| Treated Silica | 13.89 | (2.00) | 13.89 | (2.00) | 13.89 | (2.00) | 13.89 | (2.00) |
| Acrylic Polyol | 69.32 | (14.02) | 46.44 | (29.49) | 26.41 | (16.77) | 97.92 | (62.18) |
| CYMEL 202 | 6.25 | (5.0) | 6.25 | (5.0) | 6.25 | (5.0) | 6.25 | (5.0) |
| BYK 306 | 0.15 | (0.02) | 0.15 | (0.02) | 0.15 | (0.02) | 0.15 | (0.02) |
| Polyester of | — | | — | | — | | — | |
| Comparative | | | | | | | | |
| Ex C | | | | | | | | |
| Polyester of | 10.92 | (10.00) | 19.65 | 18.00) | 27.27 | (25.00) | — | |
| Comparative | | | | | | | | |
| Ex D | | | | | | | | |
| B Package | | | | | | | | |
| Phenyl Acid | 0.67 | (0.50) | 0.67 | (0.50) | 0.67 | (0.50) | 0.67 | (0.50) |
| Phosphate | | | | | | | | |
| Catalyst | | | | | | | | |
| DESMODUR N | 40.98 | | 47.51 | | 53.22 | | 32.81 | |
| 3300A | | | | | | | | |

### Application/Testing

The film-forming compositions of Examples 1-14 were spray applied to a pigmented basecoat to form color-plus-clear composite coatings over electrocoated steel panels. The test panels used were cold rolled steel panels (size 4 inches×12 inches (10.16 cm×30.48 cm)) with ED6060 electrocoat, available from PPG Industries, Inc. The ED6060 electrocoat test panels are available as APR40237 from ACT Laboratories, Inc. of Hillsdale, Mich.

The basecoat used for the Examples was HWB-73879, a red waterborne basecoat available from PPG Industries, Inc. The basecoat was automated spray applied in one coat to the electrocoated panels at ambient temperature about 21° C. A dry film thickness of about 0.7-0.9 mils (about 17-23 micrometers) was targeted. After the basecoat application, the basecoated panels were given an ambient temperature air flash for five minutes and then a dehydration bake at 93° C. for 5 minutes.

The clear coating compositions were each automated spray applied to a dehydrated basecoated panel at ambient temperature in two coats with about a thirty second ambient air flash between coats. Coatings were targeted for about 1.5 to 1.7 mils (3844 micrometers) dry film thickness. The clear coatings were allowed to air flash at ambient temperature for ten minutes. Panels prepared from each clear coating were baked for thirty minutes at 141° C. to cure the coating. The panels were baked in a horizontal position.

The coated panels prepared as described above were evaluated for 20° gloss, DOI, hardness and scratch resistance.

The 20° gloss was measured with a NOVO-GLOSS statistical glossmeter available from GARDCO.

The DOI was measured with a DOI/HAZE meter model 807A available from Tricor Systems Inc.

The hardness was the Fischer Micro Hardness Value as measured by a Fischerscope HCU (H100V-HCU program and control version HCU 19) available from Helmut Fischer GmbH.

Scratch resistance was determined by using an Amtec Car Wash Machine. The test method used consists of an Amtec Car Wash Lab Apparatus for Test Sheets and a washing suspension of 30 grams of Sikron SH200 grit per 20 liters of tap water as described in DIN 55668. The 20° gloss readings were made using a Novo-Gloss™ Statistical Glossmeter by Gardco®. Amtec Car Wash Lab Apparatus for Test Sheets and Sikron SH200 are available from Amtec Kistler GmbH.

The results of the testing are reported in Table III below.

TABLE III
Examples 1-14 Testing Results

| | | | | Scratch Resistance | |
|---|---|---|---|---|---|
| Example | 20° | | Fischer | 10 | 40 |
| No. | Gloss | DOI | Hardness | Cycles | Cycles |
| 1 | 84 | 96 | 132 | 66 | 35 |
| 2 | 84 | 97 | 130 | 71 | 44 |
| 3 | 84 | 96 | 118 | 72 | 47 |
| 4 | 84 | 96 | 111 | 75 | 56 |
| 5 | 85 | 96 | 132 | 68 | 38 |
| 6 | 85 | 97 | 136 | 63 | 31 |
| 7 | 85 | 96 | 133 | 66 | 33 |
| 8 | 48 | 16 | 133 | 42 | 23 |
| 9 | 69 | 26 | 128 | 58 | 35 |
| 10 | 85 | 96 | 139 | 64 | 31 |
| 11 | 86 | 96 | 141 | 65 | 37 |
| 12 | 86 | 97 | 146 | 68 | 39 |
| 13 | 84 | 55 | 147 | 69 | 36 |
| 14 | 83 | 96 | 133 | 68 | 34 |

The results reported in Table Ill above show that the incorporation of the polyester adjuvant resins of the invention (Examples 1-5) result in better scratch resistance compared to the control (Example 14) and similar polyester adjuvant resins but without having the moiety containing at least 10 carbon atoms positioned between the terminal hydroxyl groups (Examples 6-13).

Whereas the present invention has been described in connection with certain embodiments, the present invention is not limited to the particular embodiments disclosed, but is intended to cover modifications that are within the spirit and scope of the invention, as defined by the appended claims.

1. A clear coating composition for use over a colored basecoat comprising:
(a) a polymeric film-forming material having reactive functional groups,
(b) a curing agent having functional groups reactive with the functional groups of (a), and optionally
(c) inorganic particles, and
(d) an adjuvant resin having 2 or more terminal functional groups reactive with the functional groups of (b) and positioned between the terminal functional groups a moiety having a hydrocarbon chain of at least 10 contiguous carbon atoms, the polymer having a functional group equivalent weight of 90 to 500;
wherein when the coating composition is applied to a substrate and cured, the cured coating is characterized as having a Fischer Hardness Value of 90 to 160.

2. The composition of claim 1 containing inorganic particles and when cured having an initial 20° gloss of at least 70 and after scratch testing retaining greater than 40 percent of the initial 20° gloss.

3. The composition of claim 1 in which the Fischer Hardness Value is between 100 and 140.

4. The composition of claim 1 in which the adjuvant resin has more than two terminal functional groups.

5. The composition of claim 1 in which the functional groups of (d) are active hydrogen groups.

6. The composition of claim 5 in which the active hydrogen groups are hydroxyl groups.

7. The composition of claim 1 in which the adjuvant resin (d) is a polyester prepared from a polycarboxylic acid and a polyol.

8. The composition of claim 7 in which the moiety having a hydrocarbon chain of at least 10 contiguous carbon atoms is derived from the polycarboxylic acid.

9. The composition of claim 1 in which the moiety positioned between the terminal active hydrogen groups is a hydrocarbon chain containing at least 16 carbon atoms.

10. The composition of claim 6 in which the hydroxyl groups are derived from a triol.

11. The composition of claim 10 in which the polyol is selected from trimethylolpropane and pentaerythritol.

12. The composition of claim 7 comprising a mixture of polycarboxylic acids including the polycarboxylic acid having a moiety containing a hydrocarbon chain of at least 16 contiguous carbon atoms and a polycarboxylic acid having a hydrocarbon chain of less than 10 contiguous carbon atoms.

13. The composition of claim 12 which contains an additional polycarboxylic acid selected from linear aliphatic polycarboxylic acids having a hydrocarbon chain with less than 10 contiguous carbon atoms and a cycloaliphatic polycarboxylic acid.

14. The composition of claim 7 in which the polycarboxylic acid is a fatty polycarboxylic acid.

15. The composition of claim 14 in which the fatty dicarboxylic acid has a hydrocarbon chain of from 16 to 40 contiguous carbon atoms.

16. The composition of claim 1 in which (d) is present in the composition in amounts of 1 to 50 percent by weight based on weight of resin solids.

17. The composition of claim 16 in which (d) is present in the composition in amounts of 2 to 40 percent by weight based on weight of resin solids.

18. The composition of claim 1 as a one-package system comprising a polymeric film-forming material containing hydroxyl groups and an aminoplast resin curing agent.

19. A multilayer composite coating comprising a colored basecoat and a clear topcoat, the clear topcoat being deposited on the colored basecoat from the clear coating composition of claim 1.
